(19) United States
(12) Patent Application Publication
(10) Pub. No.: US 2025/0021462 A1
(43) Pub. Date: Jan. 16, 2025

(54) METHOD FOR FPGA BUILD AND INITIALIZATION

(71) Applicant: dSPACE GmbH, Paderborn (DE)

(72) Inventors: Heiko KALTE, Paderborn (DE); Dominik LUBELEY, Verl (DE)

(73) Assignee: dSPACE GmbH, Paderborn (DE)

(21) Appl. No.: 18/771,641

(22) Filed: Jul. 12, 2024

(30) Foreign Application Priority Data
Jul. 12, 2023 (EP) 23185063.7

(51) Int. Cl. G06F 11/36

(52) U.S. Cl. CPC G06F 11/3608

(57) ABSTRACT

A computer system for error-free execution of multiple computer-controlled build and/or initialization steps for an FPGA-based application. The computer system being set up to generate an FPGA program code as part of build steps, to transfer it to a controlled FPGA and to prepare it for execution within the framework of initialization steps. The computer system is also set up to store and/or to check results of the build and/or initialization steps centrally in a writable memory and to check whether at least one previous build and/or initialization step has been completed without errors by reading out the writable memory before a build and/or initialization step and/or before the execution of the initialization program code. This provides a computer system that avoids the disadvantages of the conventional art.

This nonprovisional application claims priority under 35 U.S.C. § 119 (a) to European Patent Application No. 23185063.7, which was filed in Europe on Jul. 12, 2023, and which is herein incorporated by reference.

### BACKGROUND OF THE INVENTION

### Field of the Invention

The invention relates to a computer system and an associated method for ensuring error-free completion of several build and/or initialization steps for an FPGA-based application, comprising a computer, a controlled FPGA and a central writable memory.

### Description of the Background Art

The invention relates in particular to the creation of program code, wherein the creation of the program code is also referred to as a Build and its result in particular as an FPGA Build Result, and initialization routines of FPGA-based control systems, especially in safety-critical environments. The modular creation of the program code of an FPGA system can include partial builds, hierarchical builds and the integration of other software modules, often referred to as plug-ins/hooks, for special applications or solutions. Software and/or hardware-based applications to be created from this often require a variety of initializations, for example, in measurement and control technology, a transient response of PLLs, gigabit transceiver connections, application and user-specific initialization parameters, I/O adjustment values, calculations and transmissions of, e.g., motor characteristics, external readout and programming of channel adjustment values and the integration of application-specific program code.

In addition, applications often require a query to see if internal/external components are ready, such as other FPGA modules, other FPGA partitions from partial reconfiguration, or other hardware components. This results in a high level of complexity for initialization as well as for the creation of the program code or build. In particular, the failure of a single, unintercepted initialization routine in an FPGA control system can result in serious damage (e.g., in advanced driver-assistance systems (ADAS/AD), electric drives, high-voltage battery simulations, aerospace applications). Therefore, before starting an FPGA application, it must be ensured that all build and initialization routines have been run correctly and error-free, otherwise operation in safety-critical applications should be aborted.

Rapid Control Prototyping (RCP) platforms for model-based design of processor and FPGA-based real-time applications have high requirements for error-free initialization and reliable operation. For the development of FPGA-based real-time applications, for example, users often have a programming environment for processors such as an FPGA at their disposal, which allows even developers without FPGA knowledge to create extensive FPGA applications, generate the program code at the push of a button and transfer it to prototype platforms for execution, for example. Subsequently, such a prototype platform can be used not only for simulation, but also as a control unit for later end-use applications in series production.

So far, the problem of a correct program code or build and correct initialization has been solved in a decentralized or sequential manner. This is done by monitoring various steps in their environment and the sequential next step implicitly assumes that previous steps have been completed correctly and that an error in the previous steps has been aborted accordingly. In practice, this often leads to an individual and error-prone application in the respective build and initialization environments. For example, if an error in a previous step is not caught correctly, it is still possible under certain circumstances that the entire build and initialization process is completed and the FPGA application is started, even though intermediate steps have caused a potentially critical, especially safety-related error. The probability of such errors is particularly high if the entire process or parts of it have been implemented by different people or vendors, for example in FPGA build processes implemented by original product developers, FPGA initialization by custom function code of an application engineer and FPGA application initialization of the user (e.g., loading of specific characteristic curves, readiness of external user hardware). Such potentially occurring conflicts can cause high damage to hardware components.

There are various approaches to increasing the reliability of FPGA-based hardware, such as the method for precise FPGA power analysis and overload avoidance described in US 2017/0116363, which is incorporated herein by reference, as well as a configuration validation method described in EP 3647801 A1, which correspond to US 2020/0132766, which is incorporated herein by reference. The configuration validation methods enable the detection of an error situation and allow the user to initiate a self-defined fail-safe behavior by means of a fail-safe signal.

In addition, according to the conventional art, a status register only contains information from the initialization and/or runtime. The number of bits and their significance in the prior art are firmly defined. However, correct initialization cannot be sufficiently guaranteed even by the configuration validation methods.

### SUMMARY OF THE INVENTION

It is therefore an object of the invention to provide a computer system that can be used to ensure improved initialization and/or creation of program code. In particular, before starting an FPGA-based application, it should be ensured that the build and/or initialization steps have been completed correctly and without errors.

According to an example of the invention, it is intended to provide a computer system for the error-free execution of a plurality of build and/or initialization steps controlled by a computer for an FPGA-based application, wherein the computer system is set up to generate an FPGA program code as part of build steps, to transfer this to a controlled FPGA and to prepare it for execution as part of initialization steps, wherein the computer system is further set up to store and/or check the results of the build and/or initialization steps centrally in a writable memory and, by reading out the writable memory before a build and/or initialization step and/or before running the initialized FPGA program code, to check whether at least one previous build and/or initialization step has been run through without errors. With regard to the aforementioned check, this includes in particular checking a critical step and logging the remaining steps. In particular, all previous steps must be completed without errors.

In this way, a computer system is provided which, especially in the case of an overall system with a plurality of software and hardware components, ensures that both build and initialization routines are run correctly and error-free before starting an FPGA-based application. The invention thus enables a safe and complete FPGA build history as well as checking the status of connected external components and model or code parts of other users.

The computer system according to the invention allows for the successful or error-free completion of the various build and initialization steps to be persisted and to make them centrally visible for all build and initialization steps, regardless of their environment (hardware/software). In this way, complex build and initialization steps can be made manageable and damage caused by incomplete build or initialization steps can be prevented. In particular, the use of a central memory allows for the results of the computer-controlled build and/or initialization steps of an FPGA-based application to be merged and/or checked. Preferably, such management of results can be achieved by setting predefined functional bits in the writable memory. The number of bits in the writable memory as well as their allocation is generally adjustable a priori, so that any plugins or external components or the users can add their own security bits for verification.

The invention represents a significant innovation for a secure development process with build and/or initialization steps of an FPGA application, which comes into effect before the application runs. It therefore represents a valuable addition to functional safety. In an advantageous extension, states and errors can also be detected and/or reported during normal runtime via the suggested mechanisms, which can then lead, for example, to a shutdown of the application or a fail-safe mode.

An FPGA refers to a field programmable gate array and thus a programmable computing unit in the form of an electronic circuit, which can be individually programmed by a user. This is usually an integrated circuit with a programmable logic gate arrangement. The circuit structure and the logic of the FPGA to be executed can usually be adapted and individually configured via a hardware description language before the bit stream generated from it is written to the FPGA. FPGAs can be used for various purposes such as system-on-a-chip applications (SoC applications with a combination of microcontroller and FPGA) and are available in different designs. Central and common components of field programmable gate arrays are flip-flops, input/output blocks, look-up tables (LUTs), clock generators, signal processors (DSPs) and storage options such as block RAM. In addition to an embedded Block RAM, information can also be stored outside the FPGA, for example with the help of DRAM, SRAM, memory cards and other technologies. The interconnection of the different components and logic modules is usually flexibly configurable in sometimes extensive degrees of freedom.

The term FPGA usually refers to a special integrated circuit (IC) in digital technology into which a logic circuit can be loaded. For numerous applications, such an FPGA can also be replaced by other components such as processors. According to the invention, an FPGA can also include an SoC.

An error-free execution of a build and/or initialization step primarily refers to a result in which no errors occur that lead to damage and/or significant consequences for the application and/or subsequent build and/or initialization steps. Such errors are often called serious errors in contrast to non-serious errors, which are often referred to as minor errors. The proposed method and/or device can detect and/or avoid both serious and minor errors.

In order to ensure that in the various phases up to the runtime of the generated program code or the connected components write results in the form of data to the correct bit positions of the writable memory, write access or authorizations can be assigned to the phases or connected components with regard to certain bit positions. This is typically done in the build using an API (Application Programming Interface). The bit positions can then be used to generate (activation) bit masks for the analysis/outputs. For example, this can be done in the following manner: Connected components send information as to how many bits they set and what kind they are, for example Build or Init. This preferably results in a total amount of build and Init bits and corresponding bit masks for automatic verification of correct initialization of all components of the computer system without the user having to intervene.

According to an example of the invention, the writable memory is a BlockRAM, which is in particular part of the FPGA. A Block RAM or block memory (BRAM) is a type of RAM that is used in FPGAs as embedded RAM. It can be used for various purposes, such as buffer storage or FIFO storage. Block RAMs typically have a fixed memory size of 4, 8, 16 or 32 kilobits per memory block and can be present in different numbers of memory blocks on an FPGA. Block RAMs are a specific type of random access memory that is used as embedded RAM memory in FPGAs, along with other components such as flip-flops, look-up tables (LUTs), and signal processors (DSPs).

The computer system can be set up to carry out a build and/or initialization step and/or the execution of the initialized FPGA program code—in particular only if the previous build and/or initialization step has been completed without errors.

The computer system can be set up in such a way that write access is granted or denied on the writable memory under predefined conditions. For this purpose, a special logic is typically implemented in the FPGA configuration. A status register, which is usually used in the prior art with regard to access control, is not protected against overwriting by subsequent initialization phases and it is therefore not ensured that bit positions of connected other components are incorrectly not written at all or even written several times. Consequently, an example provides protection against bit errors, which can be implemented by means of appropriate safety mechanisms, with which the write access to the writable memory is regulated or restricted.

The predefined conditions can be implemented in particular as a logic and relate in particular to parameters such as permission, time and frequency or rate. For example, a checksum can be calculated or parity can be checked (Parity/CRC32 Generate) after each write access. For example, the following sequence is conceivable: Read, Parity Check, Write, Parity Generate. A Parity/CRC32 check can also be carried out before each read access, which prevents bit flipping due to external influences, such as natural radioactivity.

The computer system can be set up in such a way that the computer system prevents write access to predetermined bit areas on the writable memory. In particular, write access to certain bit areas can be locked, such as the initialization area, after this has been completed.

The computer system can be set up to change only one bit per write access on the writable memory and/or to change each bit only once. Especially in the case of multiple access of a connected component, it can make sense that the latter can only change one bit per write access or that it is only given a one-time opportunity to change a bit.

Preferably, the controlled FPGA and/or FPGA-based application can be part of a real-time capable system. In particular, when the completed and/or initialized FPGA application is running, no task call, i.e., the calculation of a step, should exceed its specified task period. The term real-time capable therefore refers to a property of a system that has extremely short response times. The maximum response time is such that the essential processes and functions of the system are not impaired. Essential for real-time capability is that the application-dependent limit values for latency times are strictly adhered to. This property is particularly relevant for safety-relevant (control) systems or systems for measuring times and frequencies. In particular, real-time capable systems have latencies in the range of microseconds. The response time that is actually required depends on the use case.

The computer system can be designed to control and/or simulate a control system or parts of a control loop. Parts of a control loop also include a controller and a controlled system, in particular. In general, the aim of a control system is to keep the controlled variable as constant as possible at the value specified by the reference variable while compensating for the influences of disturbance variables. The computer and/or computer system are set up to exchange signals with an external component or a device under test.

The computer can also simulate the controller or the controlled system—optionally in addition to connected components. This can be done in particular by simulating or emulating both transmitted and received electrical signals or information from a hardware or software component.

The computer system and/or computer can be set up to perform one or more of the following build and/or initialization steps: VHDL code generation, synthesis, implementation, bitstream generation, creation of an FPGA application container.

The computer system and/or the computer can be set up to perform an integrity check on the central memory after a write access and/or before each read access. An integrity check can be carried out in particular by means of a parity check or the determination of the checksum or the so-called hash value.

The invention also includes an associated method for error-free execution of several computer-controlled build and/or initialization steps for an FPGA-based application, comprising the steps: generating an FPGA program code as part of build steps; transferring the generated FPGA program code to an FPGA; executing initialization steps in preparation to run the FPGA program code; storing and controlling the results of the build and/or initialization steps in a central writable memory; and checking in the writable memory whether previous build and/or initialization steps have been completed without errors.

It is preferable to check the writable memory at or before an Nth step (build and/or initialization step) of the bits of all previous N−1 steps to see if they have been completed correctly.

A further build and/or initialization step and/or the execution of the initialized FPGA program code can take place—in particular only—if the previous build and/or initialization step has been completed without errors. It is particularly preferred to cancel the Nth step and/or all further planned build and/or initialization steps if not all previous build and/or initialization steps have been completed correctly.

The method may use an API query to an initialization management component to allocate bit positions in the writable memory.

The initialization management component can perform the following steps: allocation of a free bit position for connected hardware and/or software components by the initialization management component, Logging of the transferred bit position and/or storage of a reference for the bit position in a writable memory.

The invention also includes the use of the prescribed method for the model-based creation of processor and/or FPGA-based applications.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration with an arrangement of a computer system according to the invention including a computer (PC), an FPGA with a writable memory and an external component (DUT) connected to the FPGA;

FIG. 2 shows an exemplary, schematic representation of a build flow; and

FIG. 3 shows a schematic illustration of the properties of a secured Block RAM or BRAM according to the invention.

### DETAILED DESCRIPTION

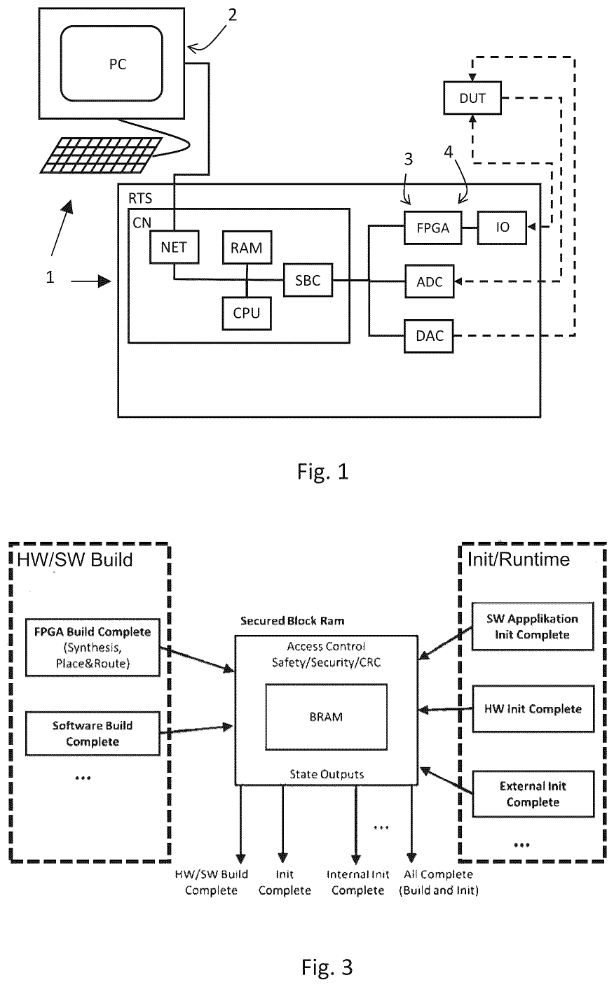

FIG. 1 shows a schematic illustration with an arrangement of a computer system 1 comprising a computer (PC), a connected real-time system (RTS, Real Time System), a computing unit (CN, Computing Node) and an FPGA 3 with writable memory 2 and external components (DUT, Device Under Test) connected to the FPGA 3 via an input/output module (IO). The external component is also typically connected to an analog-to-digital converter (ADC) and/or a digital-to-analog converter (DAC). The computer 2 serves in particular as a higher-level control unit, in particular for a rapid control prototyping (RCP) platform with typically an integrated FPGA for the model-based design of processor and FPGA-based real-time applications. In particular, the computing unit (CN) includes a memory (RAM), a processing unit (CPU), a high-speed bus SBC and a network interface NET.

Essentially, FIG. 1 includes a system for performing rapid control prototyping (RCP) or hardware-in-the-loop (HIL) simulations. RCP is to be understood in particular as a systematic approach to rapid controller development, which is increasingly used due to the increased performance of current computer hardware and software, the increasing time pressure in developments and the growing complexity of the tasks. It is expedient to first create a process model of the real process, which is used to map the relevant relationships of a process. Afterwards, a control system is created for this simulated process in the simulation.

In general, various test scenarios are conceivable as soon as the process as well as the regulation and/or control system are available in the simulation. Usually, for RCP, the control algorithm is sent to a powerful simulation hardware by means of a suitable code generation, after which the real process can be active with the control algorithm without the need for a series control unit with a microcontroller or the like, which have disadvantages for an initial development, such as limited processor power or memory space restrictions. For a HIL simulation, the process model is transferred to the simulation hardware by means of a code generator and then connected to a series ECU or the target hardware on which the regulation and/or control system is executed in later operation, thus enabling a connection between the simulated process and the target hardware. In an example, the target hardware can be created or programmed in a further step using the same code generator.

The further process often takes the form that after verification of the functioning of the control algorithm and/or adjustment of parameters by means of RCP and after examination of the target hardware by means of a hardware in the loop simulation, the target hardware and the real process are connected with each other. A standardized tool chain is advantageous for this, which allows for the described procedure from simulation and controller development to code generation, implementation and analysis of the entire system—in particular formed of process and controller.

In particular, a real-time capable simulation system for a HIL simulation includes a real-time capable simulator ES, which simulates external components in particular, a computing node CN, which is connected to the operating computer PC via a network interface NET. The computing node CN has at least one processor CPU, especially a multi-core processor, RAM memory and usually non-volatile memory, in which preferably an operating system and/or a bootloader are stored. A logic board with a programmable logic device FPGA, two I/O circuits ADC and DAC are connected to the computing node via a high-speed bus SBC or a corresponding controller. The programmable logic device FPGA is preferably freely programmable and can be configured according to the present invention. The real-time capable simulator may also have multiple logic boards or multiple programmable logic devices (FPGAs) on a logic board. The logic board preferably has one or more slots for I/O modules.

FIG. 1 also shows an I/O module IO, which is connected to the control unit under test DUT and can, for example, exchange digital input and output signals with it. The I/O circuit ADC has one or more analog-to-digital converters that receive analog signals from the control unit under test DUT. Via the I/O circuit DAC, which has one or more digital-to-analog converters, the real-time simulator can output analog signals to the control unit under test DUT.

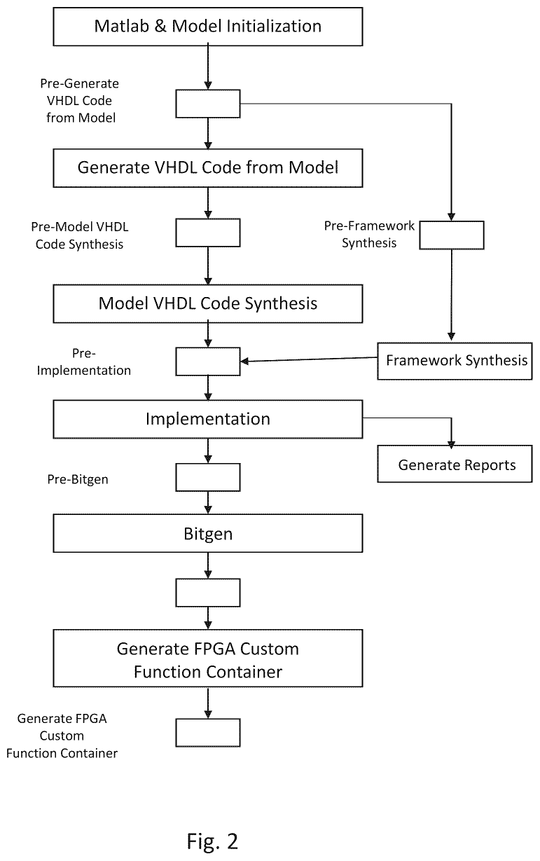

In the following, a typical FPGA build flow is described with the help of FIG. 2. FIG. 2 schematically shows an FPGA build flow with its different phases. The flow is based on an FPGA model that has been modeled by users in the MathWorks Simulink programming environment, for example. First, the user starts the build flow by initializing the FPGA model in Simulink. This is followed by the following FPGA build phases: VHDL code generation, synthesis, implementation (place & route), bitstream generation (bitgen) and FPGA custom function container generation.

These FPGA build phases have pre-and/or post-phases in which other products and applications can be integrated and modify the respective intermediate result. Hooks are used for this purpose in particular.

The programming languages used for the computer system are, for example, Matlab/Simulink (e.g.), Python (e.g.) and Xilinx Vivado (TCL scripting language). The Xilinx Vivado module can also be accessed from Python phases by calling a TCL script.

In the so-called Pre Generate VHDL Code from Model, for example, the FPGA model can still be modified. In Pre-Synthesis, the previously generated VHDL code can be accessed and modified, or modifications can be made to the Xilinx Synthesis project via TCL in advance. In the so-called “Pre Implementation”, changes to the Xilinx module are allowed via TCL before the implementation phase, pre bitgen after the implementation phase. The post bitgen allows for changes, e.g., to the bitstream, or preparations before the FPGA Custom Function Container generation, for which .xml, .c, cpp, .h code is generated. In “Post Generate FPGA Custom Function Container”, the generated .xml, .c, .cpp, .h code from other products/applications can be modified and the container can be repackaged.

The execution phase can be structured in the following way: The execution phase, in which the processor and FPGA model run on the real-time system, can be divided into an initialization (init) and a runtime phase. In the init phase, the configuration of the real-time system and thus also the FPGA boards is carried out. No real-time condition is required here. Once initialization is complete, the runtime begins, where strict real-time applies.

For the user and many associated applications, it is important that he/she can ensure in an FPGA model that all planned initializations have been successfully executed. Since the build can be influenced modularly by connected components and applications, it is not possible to ensure this by an FPGA programming block set alone. The FPGA programming block set specifically refers to a Simulink block set for using an FPGA model with a dSPACE HIL or RCP system (this requires a freely programmable FPGA in the system, typically by installing an appropriate logic board).

FIG. 3 illustrates the properties of a secured Block RAM or BRAM according to the invention.

Of great importance in an FPGA-based development environment are FPGA-external hardware components, their connection and the way in which the results of the individual steps or phases can be persisted. This requires a memory unit that is persistently writable both during the build process (i.e., before the FPGA runtime) and during FPGA operation/initialization.

For this purpose, an internal memory in the FPGA, which is standard in an FPGA and typically referred to as Block RAM, is suitable. The advantage of using Block RAM is that the placement and routing within the FPGA can remain identical, independent of set or unset status bits. The use of Block RAM also ensures reproducible build results, especially if the conditions described below are present.

The standard Block RAM (e.g., from the manufacturer Xilinx) can be protected by means of additional implemented safeguards. The access control shown in FIG. 3 represents these additional security mechanisms, as write access to the central memory is regulated or restricted, for example by the following steps, which check in particular the integrity and/or parity: (a) Perform a Parity/CRC32 Generate after each write access (sequence: Read, Parity Check, Write, Parity Generate); or (b) Perform a Parity/CRC32 Check before each read access (prevents bit flipping due to external influences); or (c) a write access may only change one bit at a time (thus preventing accidental overwriting of multiple status bits). Each bit may only be changed once. Otherwise, an Access Error will occur and the process will be aborted; and/or (d) Lock write access to certain areas (e.g., no write access to the initialization area after it has been completed)

With regard to the organization of the assignment between the inputs of the phases/components and the bit positions by means of an API query, the Init(ialization) management component is discussed in more detail below. This includes the following steps in particular:

During the build flow, the InitManagement component assigns a free bit position to all products or applications that want to set a build or Init bit. For example, the call to obtain a bitposition via the API is: bitPosition=getSecuredBlockRamBitPosition (<State>, <UniqueReference>).

The API assigns one free bit position in each case and logs for which <State> (FPGA Build, Internal Component Init, Internal Init, External Init) the position was assigned and stores the transferred <UniqueReference> (e.g., ACMC_Solution_Model_Modification, ACMC_C_Code_Init_Modification, . . . (or a unique numerical representation)) to it. This bit can also be set later via this reference.

This can be done via the methods described below to access the Secured BlockRAM with a setSecuredBlockRamBit (<UniqueReference>) function accordingly provided in the respective domain (Matlab, TCL, Python, . . . ).

The stored state information allows for the component to create the logical AND links of the Init bits during the FPGA build, so that the resulting state outputs for FIG. 3 are obtained.

As already indicated above, it is necessary to access the Secured Block RAM at very different phases (Build, Init, Runtime) and in very different environments (e.g., Synthesis, Place and Route Tool). The most important options and their phases are listed below:
[Modeling] Simulink Block: Provision of an Init bit that can be set by the model (used for the FPGA runtime)
[Synthesis] TCL command that sets a bit as part of the synthesis script (e.g., parsing the synthesis result and for certain events, an error should be displayed via a bit)
[Place&Route] TCL command that sets a bit as part of the Place&Route script (e.g., in the case of the Place&Route of partial reconfigurations, the Place/Route report detects that modules are missing or that the wrong modules have been used)
[Bitgen] TCL command that sets a bit as part of the Bitgen script (e.g., parsing the Bitgen report can be used to determine whether a Block RAM initialization has been successfully applied.)
[Software Init] write_bit_to_register( ) C function call in the Custom Function can be added by the product, the solution hooks, or the custom C code of the user.
[FPGA Runtime] Setting the Init bit logged in under Modeling (e.g., by the user's external component on a digital-in channel)

The following explanations concern access via TCL commands during the FPGA Build phases Synthesis, Place&Route and Bitgen. In particular, access during the execution of Synthesis, Place&Route, and Bitgen Tools is not so obvious. Therefore, the following shows how you can use the Xilinx tool chain to set an entry in BRAM, i.e., in the base element in the Secured Block Ram. The commands of the Xilinx tool chain for block RAM manipulation are as follows:
set_property INIT_00{256′h0000000000000000000000000000000000000 00000000000 000000000<BITMASK>} [get_cells {<SECURED_BLOCK_RAM_CELL>}]
get_property INIT_00 [get_cells {<SECURED_BLOCK_RAM_CELL>}]

However, the write call is encapsulated in a TCL function setSecuredBlockRamBit(<UniqueReference>), which meets the following security requirements:

To ensure that individual bits can also be set within an existing bitmask, the setting is carried out by means of Read-Modify-Write of the bitmask. Each bit can only be written to once. Since access can be made from different FPGA build phases or different scripts, the access information is persisted via a) the file system or b) another Block RAM in the FPGA. There it is stored whether the respective bits have already been accessed. If so, no further write operation is performed.

In addition, the Access Control also offers various options for analysis, see also FIG. 2: Output/info as to whether the build was run completely and correctly; In the event that the Initphase was run successfully: Check with a bitmask, which then sets the Init Complete output. One specification could be that all bits of the Build and the Init phase must be set to 1 in order for the Init phase to be completed successfully.

In addition, it is conceivable that there are also activation requests in the Init phase from RTLib with the activation mask sent. This facilitates optional conditions.

In order to include external hardware components in the Init phase, there is also one (or more) internal Init complete signal(s) in addition to the Init complete signal. This type of signal signals to connected external hardware components that the simulator hardware is fully initialized and is only waiting for external components (or a specific external hardware component in each case). This allows for them to also complete their initialization, in which they may have waited for the simulator, and then return their External Init Complete Signal to the simulator so that the simulator can transition to the full Init Complete. This avoids possible deadlocks, in which the simulator and external hardware components would otherwise wait for each other's Init Complete.

The method described above can also be applied to FPGA-internal components (e.g., LVDS or MGT initialization/FPGA partitions), which first activate each other via an Internal Component Init Complete Signal in Access Control in order not to remain deadlocked.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer system to run several build and/or initialization steps controlled by a computer for an FPGA-based application,
wherein the computer system being set up to generate an FPGA program code as part of build steps, to transfer it to an FPGA and to prepare it for execution within the framework of initialization steps, and
wherein the computer system is further set up to store and/or control the results of the build and/or initialization steps centrally in a writable memory and to check by reading the writable memory before a build and/or initialization step and/or before the initialization program code has been run as to whether at least one previous build and/or initialization step has been completed without errors.

2. The computer system according to claim 1, wherein the writable memory is a Block RAM of the FPGA.

3. The computer system according to claim 1, wherein the computer system is set up to perform a build and/or initialization step and/or the running of the initialized FPGA program code only if the previous build and/or initialization step has been completed without errors.

4. The computer system according to claim 1, wherein the computer system is set up to grant write access to the writable memory under predefined conditions.

5. The computer system according to claim 1, wherein the computer system is set up to prevent write access to predetermined bit areas on the writable memory.

6. The computer system according to claim 1, wherein the computer system is configured to change only one bit per write access on the writable memory and/or to change each bit only once.

7. The computer system according to claim 1, wherein the controlled FPGA and/or the FPGA-based application is part of a real-time capable system.

8. The computer system according to claim 1, wherein the computer system is designed to control and/or simulate a control system or parts of a control loop.

9. The computer system according to claim 1, wherein the computer is set up to perform one or more of the following build and/or initialization steps: VHDL code generation, synthesis, implementation, bitstream generation, creation of an FPGA application container.

10. The computer system according to claim 1, wherein the computer system is set up to perform an integrity check on the writable memory after a write access and/or before each read access.

11. The computer system according to claim 10, wherein the computer system is set up to perform an integrity check on the writable memory via a checksum.

12. A method for error-free execution of multiple build and/or initialization steps controlled by a computer for an FPGA-based application, the method comprising:
generating an FPGA program code as part of build steps;
transferring the generated FPGA program code to an FPGA;
running initialization steps in preparation for an execution of the FPGA program code;
storing and controlling the results of the build and/or initialization steps in a central writable memory; and
checking, in a writable memory, as to whether at least one previous build and/or initialization step has been completed without errors.

13. The method according to claim 12, further comprising the step of:
performing a further build and/or initialization step and/or running the initialized FPGA program code only if the previous build and/or initialization step has been completed without errors.

14. The method according to claim 12, further comprising the step of:
assigning bit positions in the writable memory to an initialization management component via an API query.

15. The method according to claim 14, wherein the initialization management component performs the following steps:
assigning a free bit position for connected hardware and/or software components; and
logging the transferred bit position and/or storing a reference for the bit position in a writable memory.
